(19) United States
(12) Patent Application Publication
(10) Pub. No.: US 2026/0152250 A1
(43) Pub. Date: Jun. 4, 2026

(54) HYBRID STRUCTURE ALLOWING DETACHABLY ATTACHING THERETO AN ADD-ON ELEMENT

(71) Applicant: Tetro Ltd., Hong Kong (HK)

(72) Inventor: Ilan BEN MEIR, Ra'anana (IL)

(21) Appl. No.: 18/707,681

(22) PCT Filed: Nov. 7, 2022
(86) PCT No.: PCT/IL2022/051176

§ 371 Date: May 6, 2024

(30) Foreign Application Priority Data
Nov. 8, 2021 (IL) 287934

(51) Int. Cl. B62J 11/00; B32B 3/30; B32B 5/18; B32B 7/05; B32B 7/08; B32B 27/06; B32B 27/32; B62J 1/20

(52) U.S. Cl. CPC B62J 11/00; B32B 3/30; B32B 5/18; B32B 7/05; B32B 7/08; B32B 27/065; B32B 27/32; B62J 1/20; B32B 2250/02; B32B 2250/242; B32B 2605/00

(57) ABSTRACT

A hybrid structure configured for detachably attaching thereto an add-on element by at least one connector, comprises a core member having an outer surface and at least one connector receiving element positioned within the core member; and a covering layer connected to the core member by a connection arrangement other than the connector. The covering layer has an internal surface configured to face the core member and an opposite external surface. The covering layer comprises at least one hole extending between its internal surface and external surface, and this at least one hole is aligned with the at least one connector receiving element, for providing access thereto for the connector in a first orientation. The connector receiving element is configured to allow displacement of the connector into a second orientation within the connector receiving element, thereby locking the connector therein.

### BACKGROUND

Articles or products having suspension characteristics/quality to improve softness comfort of users are well known. These include cycle seats, motor vehicle seats, chair components, sofas, and interior car parts that suspend or compress upon application of force thereon.

Conventionally, the articles are formed of different materials often including an elastic foam layer compressible to provide suspension quality thereto, covered by an external fabric layer, joined by means of adhesives or by heat treatment or by sawing. One or more of the multiple layers can absorb energy and reduce impact on the users when the users apply a force on the article.

Materials used as layers in the above articles are often thermoset and non-recyclable, adding to the ever-increasing environmental waste. Examples of these materials are Polyurethane (PU), Polyvinyl chloride (PVC), or Ethylene-vinyl acetate (EVA).

### GENERAL DESCRIPTION

According to one aspect of the presently disclosed subject matter, there is provided a hybrid structure configured for detachably attaching thereto an add-on element by at least one connector, said structure comprising:
a core member having an outer surface and at least one connector receiving element accommodated within the core member and accessible from an exterior of the core member at said outer surface so as to allow said connector to be detachably attached thereto; and
a covering layer having an internal surface configured to face the core member and an opposite external surface, said covering layer comprising at least one hole extending between its internal surface and external surface, said at least one hole being aligned with said at least one connector receiving element, for providing access thereto for said connector in a first orientation, and said connector receiving element being configured to allow displacement of said connector into a second orientation within the connector receiving element, thereby locking said connector therein;
a connection arrangement other than said connector and the at least one connector receiving element, mechanically connecting the covering layer to the core member,
materials from which the core member, the covering layer, the connection arrangement and the at least one connector receiving element, are made, are meltable at the same recycling temperature.

The add-on element can be any element directed to enhance the usability of the product that is made from the hybrid structure. For instance, the product can be a seat and the add-on element can be a safety harness, or the product can be an interior car part and the add-on can be a mobile phone holder, etc. The add-on element can be a washable cover whose detachable attachment to the hybrid structure can facilitate hygienic use of the product made of the hybrid structure, when it is intended for being contacted by a plurality of users, such as a seat or a headrest.

In some examples, the covering layer can be a thin rigid covering layer and the core member can be a thick rigid core member, and they can have a reduceable-volume layer therebetween, all connected to each other by said connection arrangement so as to provide a suspension quality to the structure, when a flexing force is applied to the covering layer.

In the present description and claims, and unless specifically indicated otherwise, the term ‘force’ or ‘flexing force’ means a force under which the suspension quality is to be provided, directed at least partially along the thickness direction of the covering layer and the structure, i.e. direction perpendicular to an exterior surface of the covering layer; the term ‘rigid’ used with respect to a component or material means ‘substantially rigid to maintain its shape as produced and be either incompressible under the above force (e.g. as the covering layer) or having a substantially lower compressibility under said force than an elastic foam (e.g. as in the core member)’; the term ‘suspension quality’ means an ability of a plurality of regions of the covering layer to flex towards the core member when the flexing force is applied to each such region while maintaining the thickness of the covering layer at said region, and to flex back when the flexing force is released; the term ‘thin’ with respect to the covering layer means that the thickness of this layer is so small as to allow it to be flexible as described above, and the term ‘thick’ with respect to the core member means that the thickness of this member substantially exceeds that of the covering layer, and is thick enough to securely hold the covering layer thereon by means of the connection arrangement.

The reduceable volume layer can have a thickness exceeding that of the covering layer at least at said regions, and it can be constituted either by a plurality of air gaps formed between the outer surface of the core member and the internal surface of the covering layer spaced from each other, e.g. by bumps in on the outer surface of the core member and/or on the internal surface of the covering layer; or by such gaps in combination with an elastic layer portions accommodated therein; or by an elastic layer disposed between the covering layer and the outer surface of the core member which is free of the above air gaps. When the elastic layer is used, with or without the air gaps, it is configured to be elastically compressed by said regions of the covering layer upon the application of said flexing force thereon.

The connection arrangement can comprises an array of lockable portions associated with the internal surface of the covering layer and an array of corresponding locking portions in the core member, said locking portions lockingly engaging at least partially the corresponding lockable portions.

According to another aspect of the presently disclosed subject matter, there is provided a core member configured for connecting thereto a covering layer by a connection arrangement comprising lockable portions associated with the covering layer, and further configured for detachably attaching thereto an add-on element by at least one connector other than the connection arrangement, said core member comprising:
an array of locking portions constituting a part of the connection arrangement, said locking portions being configured to lockingly engage at least partially corresponding lockable portions associated with the covering layer; and
at least one connector receiving element, other than the locking portions, said at least one connector receiving element being configured to be detachably attached to the add-on element by said connector;
the core member, the locking portions and the at least one connector receiving element being made of materials meltable at the same temperature.

In the hybrid structure and the core member according to the above aspects, the connector receiving element/s can be configured to allow insertion therein and removal therefrom, through an opening in the outer surface of the core member, of the connector only in a particular orientation thereof, i.e., a first orientation. The connector receiving element can be further configured to allow changing the orientation of the connector to a second orientation within the connector receiving element to lock the connector within the connector receiving element when the add-on is to be attached to the core member and unlock the connector from the connector receiving element when the add-on is to be detached from the core member. The connector receiving element is configured to allow rotation of the connector within the connector receiving element for allowing displacement of the connector between the first and the second orientation. The connector receiving element/s can be further configured to allow and/or cause axial displacement of the connector during the change in orientation thereof, thereby rendering the locking more secure. Moreover, the connector receiving element can be configured to allow and/or cause axial displacement of the connector in at least in a direction in which the connector is inserted into the connector receiving element at least when the connector is in its second orientation, thereby maintaining the suspension quality of the structure at the areas corresponding to the connector as well.

The locking portions and/or the connector receiving element/s can be reinforced meaning that they can be made of a material which is stronger, e.g. has a higher bulk density, than the material which at least partially surrounds them.

The hybrid structure and/or the core member of the above aspects can have a plurality of connector receiving elements including said at least one connector receiving element, the connector receiving elements constituting a part of a structure made of a material having at least one characteristic other than that of the material of the core member, the structure with the connector receiving elements being optionally formed as a unitary body. The locking portions of the connection arrangement can constitute a part of the structure and can be made of a material meltable at the same temperature as that of the core member and the covering layer. The structure can be reinforced relative to the core member. The reinforced structure can be continuous, i.e. having all portions and elements thereof connected to each other, or rather can be discontinuous and have at least some of its portions and elements being discrete, i.e. not connected to any other portions or elements of the reinforced structure. The reinforced structure can constitute a skeleton for the core member facilitating its strength and stability, when necessary.

In some examples, the reinforced structure can be configured to be assembled with the core member after the core member and the reinforced structure have been fabricated. In other examples, the core member can be over-molded onto the reinforced structure.

According to a third aspect of the presently disclosed subject matter, there is provided a kit comprising a hybrid structure according to any of the above described examples and at least one connector configured to be detachably attached at a first end thereof to the hybrid structure and at an opposite second end to an add-on to be attached to the hybrid structure.

In all examples described above, the connection arrangement between the covering layer and the core member can connect them fixedly and flexibly, wherein in the present description and claims, the term “fixedly’ means that the connection is permanent, i.e. the covering layer cannot be readily disconnected from the core member, and the term ‘flexibly’ means that the connection allows the suspension quality mentioned above, i.e. a plurality of regions of the covering layer to flex towards the core member when the flexing force is applied to each such region and to flex back when the flexing force is released.

In all the examples described above, the hybrid structure can have all or at least most of its components and connection elements made of materials allowing their recycling including thermal processing thereof, without separation between the core member and the layers. For example, the materials of at least the core member, the covering layer, the connection arrangement, and the connector receiving element can comprise the same basic thermoplastic substance or different basic thermoplastic substances that are meltable at the same recycling temperature, with said/each basic substance being the only substance within said materials that melts at said temperature. The basic substance/s of the materials from which the core member, the covering layer, the connection arrangement therebetween and the at least one connector receiving element, whether or not reinforced, are made can be recyclable thermoplastic polymers of the same polymer family, e.g. such as polypropylene family, having different material forms. Such components can have a total weight which constitutes more than 90%, optionally, more than 93%, e.g. at least 95%, of the weight of the entire hybrid structure. For example, the material of the core member can be in the form in an expanded particle foam, and the material of each of the covering layer, the connection arrangement and the connector receiving element/s, whether or not reinforced, can be a compact material having a bulk density higher than that of the core member. In this case, the core member can be formed by particle-foam molding into a desired shape and the covering layer can be made by injection molding or compression molding, thermoforming, extrusion, vacuum forming, or other technologies, allowing the covering layer and the connecting elements to maintain their shape as produced.

The elastic layer, if any, can have weight, which can constitute a minor fraction of the weight of the entire hybrid structure, so even if it is made of a material not meltable at the above recycling temperature, it can be recycled together with the other components of the hybrid structure without separation therefrom.

### BRIEF DESCRIPTION OF THE DRAWINGS

In order to better understand the subject matter that is disclosed herein and to exemplify how it may be carried out in practice, embodiments will now be described, by way of non-limiting examples only, with reference to the accompanying drawings, in which:

FIG. 1A illustrates a connector and a cross-sectional view of a connector receiving element configured for connecting the connector thereto in a hybrid structure (a small portion of which associated with the connector receiving element being shown) according to an example of the subject matter of the present application.

FIG. 1B is a front perspective view of the portion of the hybrid structure illustrated in FIG. 1A.

FIG. 1C is another front perspective view of the portion of the hybrid structure illustrated in FIG. 1A.

FIG. 1D is a front perspective view of a portion of a hybrid structure according to another example of the presently disclosed subject matter, with a connector receiving element fully disposed within a core member of the hybrid structure.

FIG. 1E is a close-up bottom view of the connector receiving element illustrated in FIG. 1A.

FIG. 1F is a front perspective view of the connector illustrated in FIG. 1A.

FIG. 1G is a plan view of the connector illustrated in FIG. 1F.

FIG. 1H is a cross-sectional view taken along a plane A-A in FIG. 1G.

FIG. 2A illustrates a sectional view of a portion of a hybrid structure which can constitute the hybrid structure of FIG. 1A, according to an example of the presently disclosed subject matter, the section being taken along a plane not passing through the connector receiving element shown in FIG. 1A.

FIG. 2B illustrates the hybrid structure of FIG. 2A in operation, illustrating the suspension quality of the hybrid structure.

FIG. 2C illustrates a sectional view of a portion of the hybrid structure of FIGS. 2A and 2B, comprising a connection arrangement.

FIG. 2D illustrates the hybrid structure of FIG. 2C in operation, illustrating the suspension quality of the hybrid structure.

FIG. 2E illustrates a sectional view of a portion of another hybrid structure which can constitute the hybrid structure of FIG. 1A according to yet another example of the presently disclosed subject matter; the section being taken along a plane not passing through the connector receiving element shown in FIG. 1A.

FIG. 2F illustrates a perspective sectional view of a hybrid structure illustrated in FIG. 2E comprising a connection arrangement;

FIG. 3A illustrates a sectional view of a hybrid structure including a connection arrangement, according to a still further example of the subject matter of the present application.

FIG. 3B illustrates the hybrid structure of FIG. 3A in operation.

FIG. 3C illustrates a sectional view of a double-sided hybrid structure according to a yet another example of the subject matter of the present application, being similar to the hybrid structure of FIG. 3A.

FIG. 4A illustrates an exploded top perspective view of a core member which can be used in hybrid structure in accordance with a further example of the subject matter of the present application.

FIG. 4B illustrates an exploded view of a hybrid structure according to yet even further example of the subject matter of the present application, comprising the core member of FIG. 4A.

FIG. 4C illustrates an assembled view of the hybrid structure of FIG. 4B with an add-on connector not connected thereto.

FIG. 4D illustrates an assembled view of the hybrid structure of FIG. 4C with the add-on connector connected thereto.

### DETAILED DESCRIPTION OF EMBODIMENTS

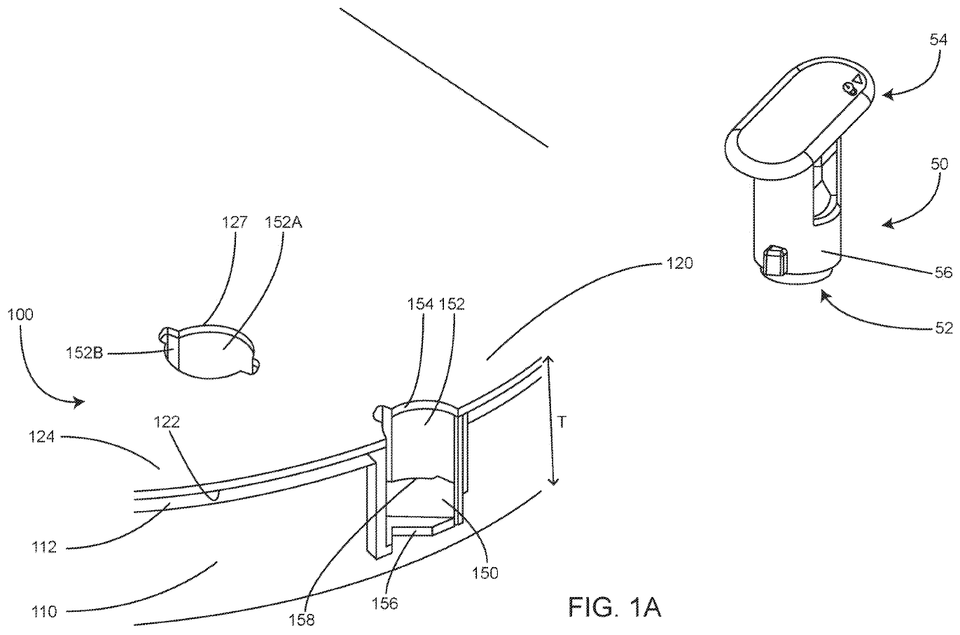

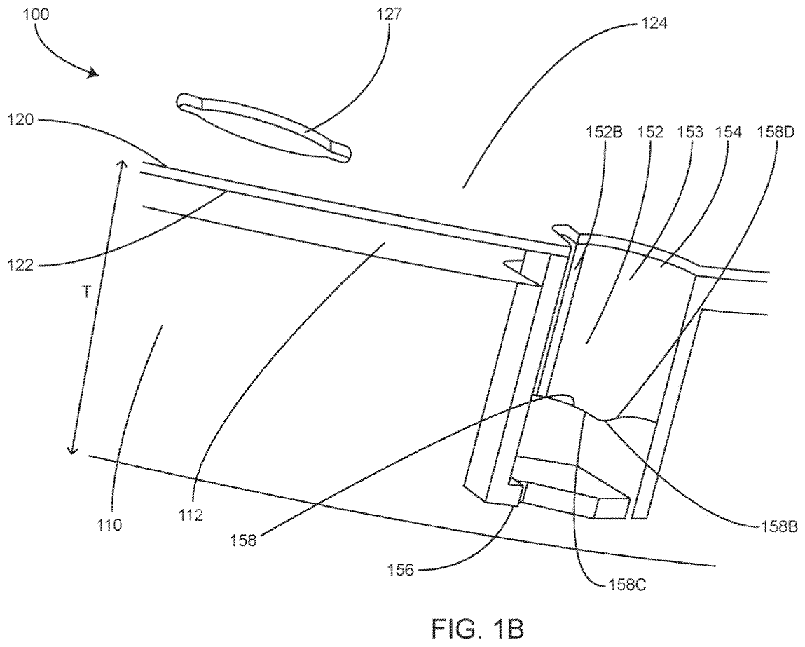

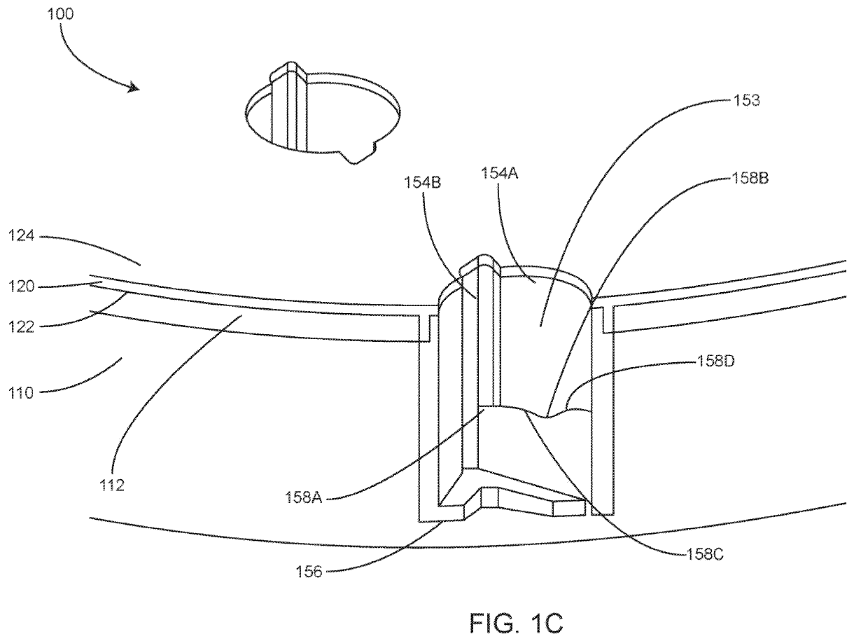

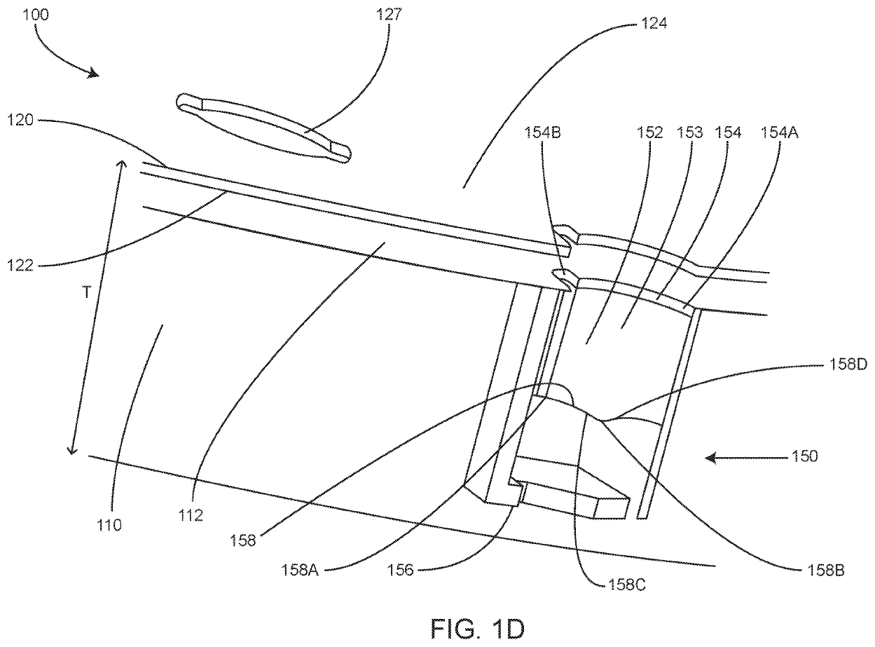

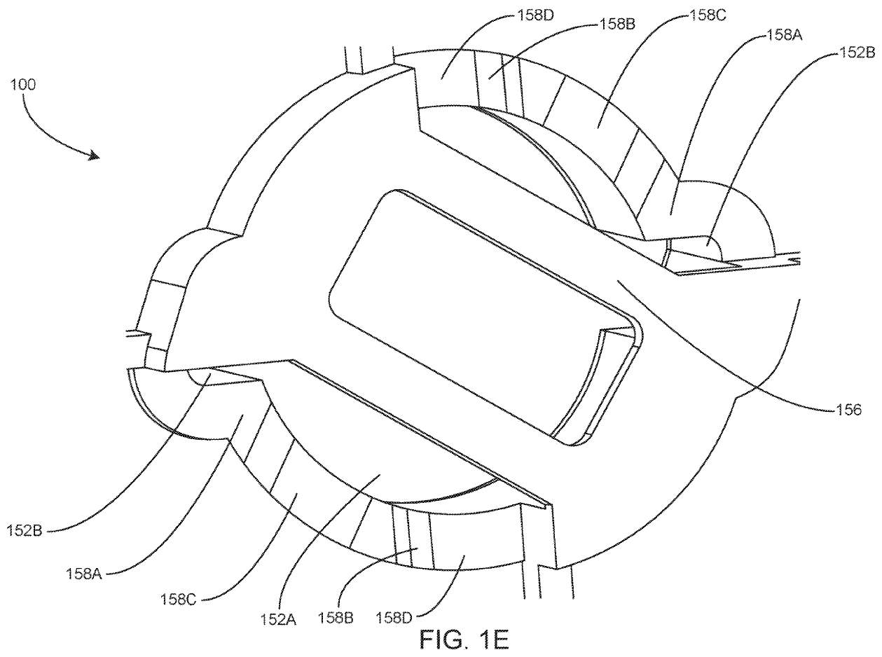

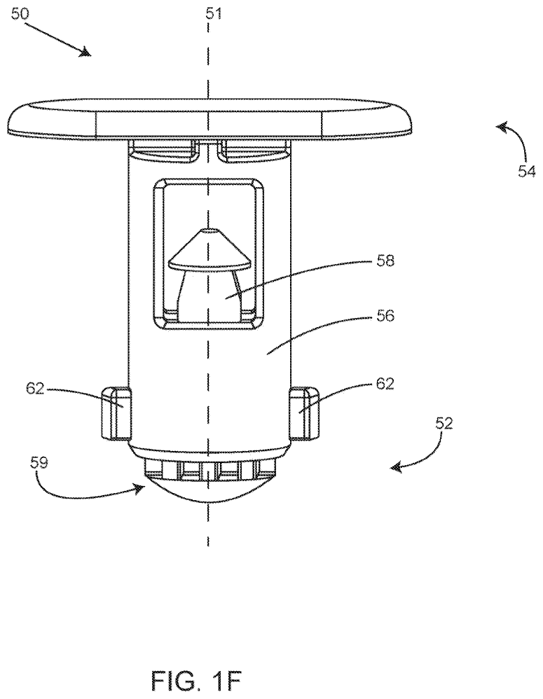

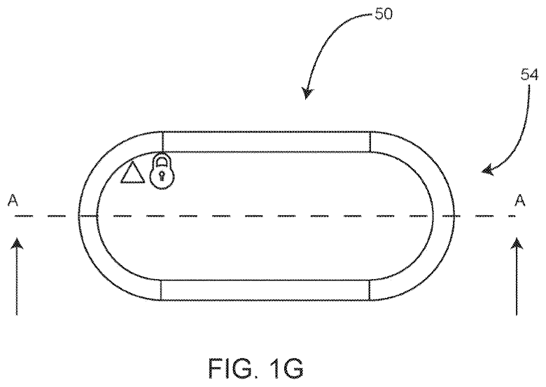

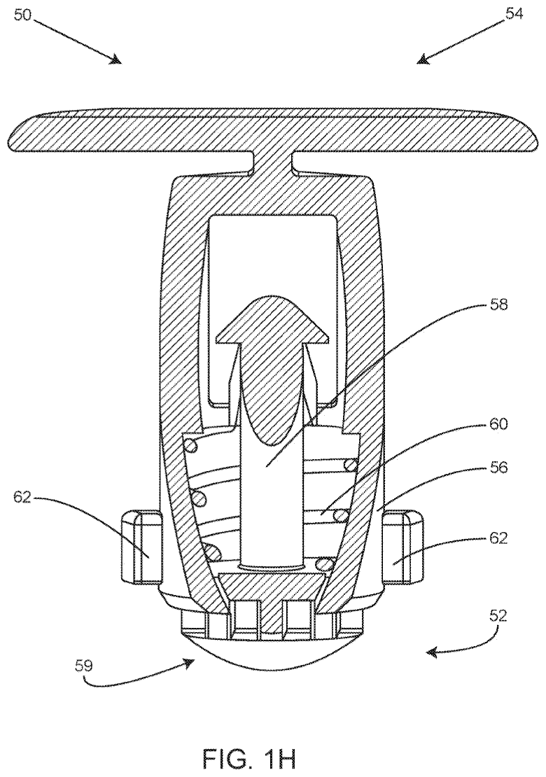

Attention is first directed to FIG. 1A illustrating a portion of a hybrid structure 100, in accordance with one example of the subject matter of the present application, and a connector 50 for attaching thereby to the hybrid structure 100 an add-on element (not shown).

The hybrid structure 100 can constitute a portion of an article to be incorporated into a product configured to be attached with an add-on element to enhance the usability thereof.

The product can be, for example, a bicycle seat, a motor vehicle seat, a chair component, a sofa, an interior car part, etc.

The add-on element can be any element that can/should detachably attach to the product. For instance, when the product is a seat the add-on element can be a safety harness, or when the product is an interior car part, the add-on can be a mobile phone holder, etc.

According to one example, the product can be intended for use by a plurality of users, e.g., a seat or a headrest, and the add-on element can be a washable cover which is detachably attachable to the product, to facilitate hygienic use therein.

The detachable attachment of the add-on to the product can be facilitated by the hybrid structure 100. The add-on can include a connector 50, while the hybrid structure 100 includes a plurality of connector receiving elements 150, to which the connector 50 can be detachably attached.

FIGS. 1B to 1E show additional views of the connector receiving elements 150 in the hybrid structure 100, and FIGS. 1F to 1H show additional views of the connector 50.

The hybrid structure 100 includes a core member 110 accommodating the connector receiving elements 150, and a covering layer 120 accommodating respective holes 127 aligned with the connector receiving elements 150, for providing access thereto for the connector 54. The arrangement of the connector receiving elements 150 in the core member is such that they extend from an outer surface 112 of the core member 110 thereinto.

The covering layer 120 has an internal surface 122 facing the core member 110, and an external surface 124 facing the exterior of the hybrid structure 100, and having a thickness therebetween extending in a thickness direction T.

Although not illustrated in the figures mentioned hereinabove, it should be appreciated that the covering layer 120 is fixedly attached to the core member 110 by a connection arrangement, other than the connector 50, of which examples will described hereinafter.

As mentioned, the covering layer has holes 127 corresponding to and aligned with the connector receiving elements 150. The holes 127 extend between the internal surface 122 and the external surface 124 of the covering layer 120 and are configured to provide access to the corresponding connector receiving elements 150 for the corresponding connectors 50.

It should be appreciated that other examples of the presently disclosed subject matter include only one hole such as the holes 127, and only one connector receiving element such as the connector receiving element 150, optionally when it is desired to connect an add-on which can be connected through a single connection.

In general, the connector receiving element can have a hollow body extending in the thickness direction T of the hybrid structure between an open end thereof associated with the outer surface of the core member, through which the interior of the body is accessible by the connector, and a closed end within the core member. The connector receiving element can comprise an engaging portion configured to engage and detachably lock the connector. The connector can have a first end configured to be inserted into the connector receiving element and to be detachably locked at the engaging portion and a second end configured for attaching thereto the add-on element to be mounted to the hybrid structure. The hollow body of the connector receiving element can be configured to allow insertion and removal of the first end of the connector in a particular first orientation by virtue of its dimensions and/or shape. The hollow body of the connector receiving element can be further configured to allow displacement of the connector between the first orientation and a second orientation in which the first end of the connector is locked at the engaging portion. For instance, at the second orientation, the first end of the connector can have a spatial arrangement and/or dimension with respect to the hollow body different than that at the first orientation. In a particular example, the first end of the connector can have radially extending protrusions whose spatial arrangement and/or dimensions with respect to the hollow body allow the locking and unlocking of the connector at the engaging portion when the connector displaces from the first to the second orientation an vice versa, respectively.

The connector receiving elements can be reinforced, i.e. be made of a material which is stronger, e.g. has a higher bulk density, than the material of the core member.

The connector receiving element can be further configured to allow axial displacement of the connector within the connector receiving element along the thickness direction, upon insertion of the connector into the connector receiving element and when the first end of the connector is locked therein.

In the present example, the hollow body of the connector receiving element 150 is designated as 152, and its open end and closed end are designated as 154 and 156 respectively. The engaging portion is designated as 158. The body 152 has a main body portion 152A and two side body portions 152B. The open end 154 has main opening portion 154A corresponding to the main body portion 152A and two side opening portions 154B corresponding to the side body portions 152B. In some examples, there can be either one or more than two side body portions and corresponding side opening portions as well.

The engaging portion 158 is formed as two recesses 158, each extending radially in the wall 153 of the main body 152 between a first engaging end 158A aligned with a corresponding side body portion 152B and a second engaging end 158B. As can be best seen in FIG. 1C, the recess 158 has a slope 158C towards the closed end 156 starting from the first engaging end 158A going towards the second engaging end 158B. The second engaging end 158B is defined by a depression 158D extending away from the closed end 156 of the main body 152. In the illustrated example, there are two recess 158, each extending completely through the wall of the main body 152, however, in other examples (not shown), there can be one or more than two recesses, each or some of them extending up to a depth less than thickness of the wall of the main body.

As best seen in FIGS. 1F to 1H in the present example, the connector 50 has a housing 56 extending along a longitudinal axis 51. A push pin 58 is positioned within the housing 56 and is configured for restricted axial displacement between a pressed state and a relaxed state within the housing 56 along the longitudinal axis 51. The push pin 58 has an abutting portion 59 protruding from the housing 56 in the direction along the longitudinal axis 51 and constituting a part of the first end 52 of the connector 50. The connector 50 has a biasing element, which in the present example is a spring 60, configured to bias the push pin 58 towards its relaxed state. The housing 56 of the connector 50 has two protrusions 62 protruding radially outwards therefrom in a direction away from the longitudinal axis 51. In other examples, there can be either one protrusion, or more than two protrusions, based on the number of side body portions and corresponding side opening portions in the reinforced receiving portions of the hybrid structure.

The connector receiving element 150 is configured to receive therewithin the connector 50 from its first end 52 in a first orientation, i.e., when the protrusions 62 are aligned with the side opening portions 154B and/or the side body portions 152B, and to prevent that insertion/removal in the second orientation. The holes 127 in the covering layer 120 have the same shape as, and are aligned with, the side opening portions 154B to enable insertion, and removal as well, of the first end 52 of the connector 50 therethrough in the first orientation. The core member 110 has openings formed in the outer surface 112 having the shape and size corresponding to the open ends 154 and the holes 127, and configured to provide access to the corresponding connector receiving elements 150 for the connector 50 in the first orientation only.

In the present example, the connector receiving elements 150 protrude from the outer surface 112 of the core member 110 into the covering layer 120 and have their open ends 154 flush with the internal surface 122 of the covering layer 120. In other examples, the open ends of the connector receiving elements can be disposed within the covering layer, i.e. between its external and internal surfaces. Alternatively, the connector receiving elements can be fully disposed within the core member and their open ends can thus be flush with or be positioned completely below the outer surface of the core member. This option is illustrated in FIG. 1D.

As can be seen in FIG. 1D, the connector receiving element 150 is fully disposed within the core member 110 with no portion of the connector receiving element 150 protruding from the outer surface 112 of the core member 110.

In operation, the connector 50 is inserted into the connector receiving element 150 until the abutting portion 59 abuts the closed end 156 of the connector receiving element 150. The dimensions of the connector 50 and the connector receiving element 150 in the direction along the longitudinal axis 51 are such that when the abutting portion 59 abuts the closed end 156, the protrusions 62 engage the first engaging ends 158A of the corresponding recesses 158. At this position, the push pin 58 is in its relaxed state. Then, the connector 50 is rotated, by the second end 54, within the connector receiving element 150 causing the protrusions 62 to slide into the corresponding recesses 158 towards the second engaging ends 158B, eventually getting locked into the depressions 158D. The slope 158C of the recess 158 causes the push pin 58 to displace towards its pressed state as the connector 50 is rotated, until the projections 62 reach just before the depressions 158D, where the push pin 58 reaches its pressed state. Thus, the slope 158C allows axial movement of the connector 50 within the connector receiving element 150 during displacement of the connector from its first orientation to the second orientation. The dimensions of the depressions 158D are such that when the protrusion 62 gets locked therein, the push pin 58 displaces into its relaxed state or an intermediate state between the relaxed state and the pressed state. For instance, the push pin 58 is in its relaxed state when the protrusions 62 are at the first engaging ends 158A and at the pressed state when the projections 62 are just adjacent the depressions 158D. When the protrusions 62 get locked into the depressions 158D, the push pin 58, due to the biasing action of the spring 60, displaces at least partially towards its relaxed state. At this position, the connector 50 is in its second orientation. As can be seen in the figures, the connector 50 cannot be removed from the connector receiving element 150 when at its second orientation.

Furthermore, the dimensions of the depressions 158D and the projections 62 are such that when the connector 50 is locked, it cannot be rotated in a reverse direction, as compared to that for locking, until the projections 62 are out of the depressions 158D.

In order to unlock the connector 50 from the connector receiving element 150, the connector 50 is pushed inward into the connector receiving element 150, that causes the push pin 58 to displace into its pressed state and the projections 62 move out of the depressions 158D. At this position, the connector 50 is rotated in the reverse direction and the projections 62 slide in the recesses 158 from the second engaging ends 158B to the first engaging ends 158A. Only then, the connector 50 can be removed from the connector receiving element 150. Thus, the slope 158 allows axial movement of the connector 50 within the connector receiving element 150 during displacement of the connector 50 from its second orientation to the first orientation.

The hybrid structure 100 is shown in FIGS. 1A-1D in a simplified manner, since these figures are mostly directed to illustrate its connector receiving elements 150, and the ability of each such element to lockingly receive therein a connector 50 by which an add-on can be connected to the hybrid structure 100, while allowing axial displacement of the connector 50. However, such axial displacement not only allows the connector 50 to change its orientation when necessary but can also allow it not to interfere with suspension quality the hybrid structure 100 can have.

One option for achieving such suspension quality is the hybrid structure comprising a reduceable-volume layer between the covering layer and the core member. The covering layer can be configured to flex into the reduceable-volume when a flexing force is applied to its external surface. In this case, the connector receiving element should be fully disposed within the core member and the connector should be able to pass through the reduceable-volume layer when it is inserted into the connector receiving element.

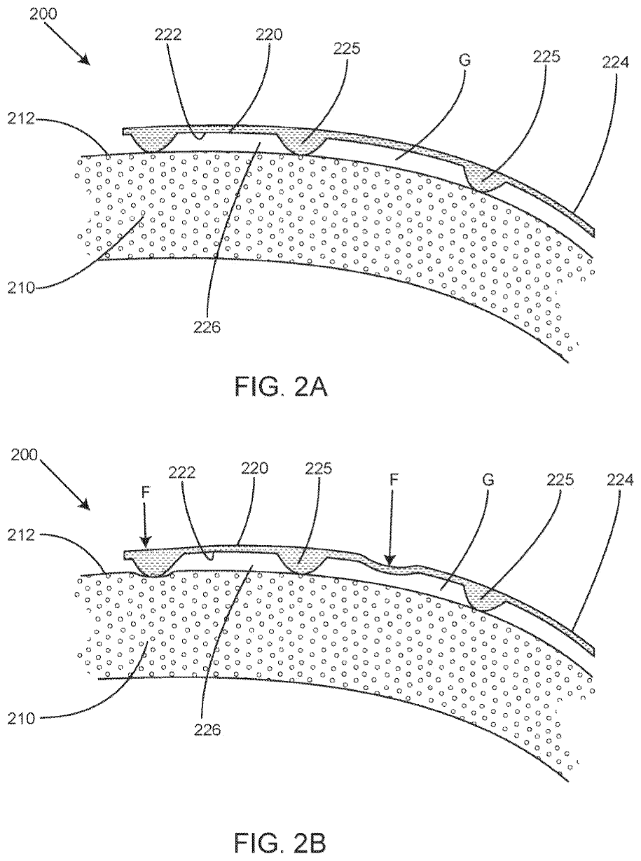

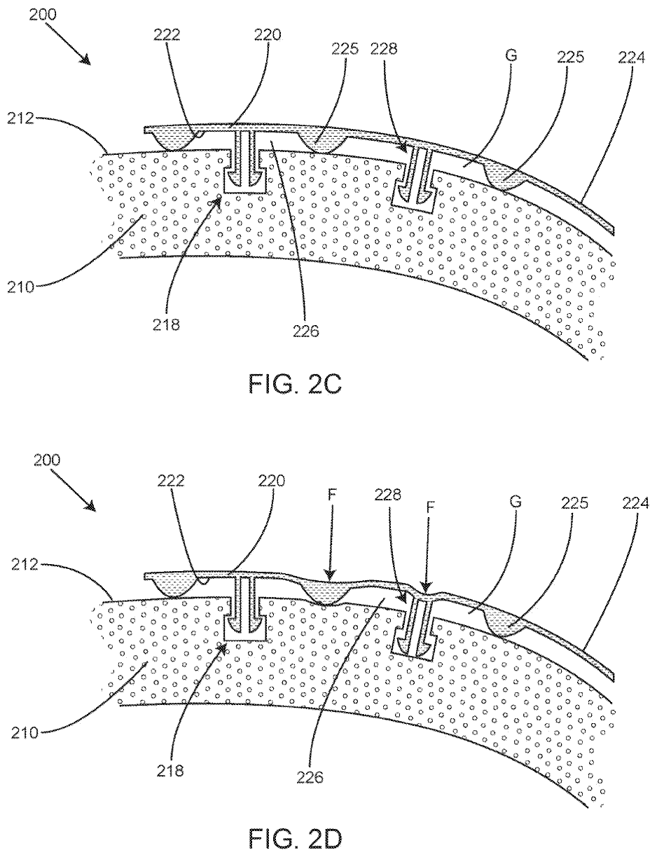

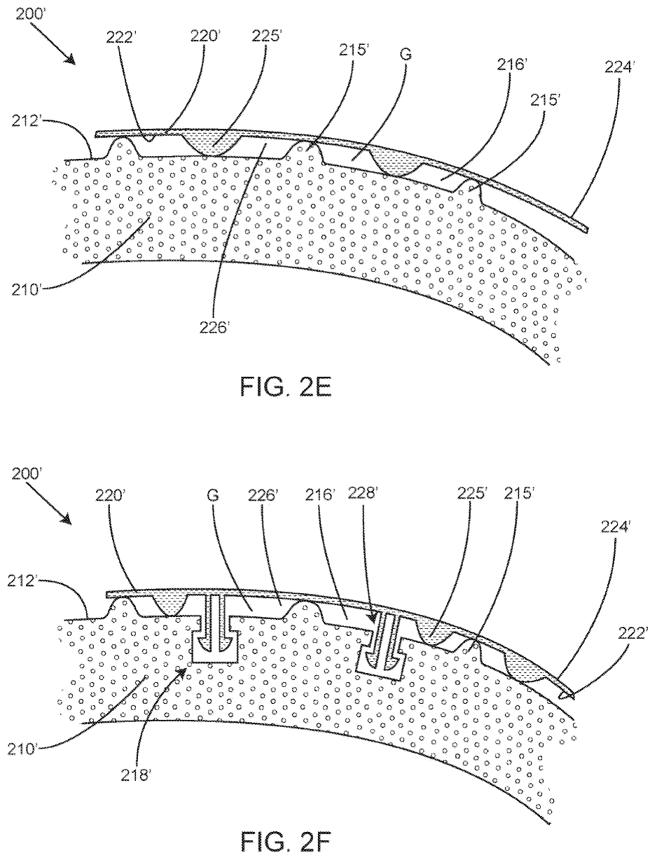

Whilst the reduceable volume layer is not shown in the hybrid structure 100 of FIGS. 1A-ID, it can be present in this hybrid structure as well as any other hybrid structure which comprises a core member with connector receiving portions and a covering layer, in accordance with the presently disclosed subject matter. For example, the reducible volume layer can take one of the following forms: a plurality of air gaps formed between the outer surface of the core member and the internal surface of the covering layer spaced from each other, or such gaps in combination with an elastic layer portions accommodated therein; or an elastic layer disposed between the covering layer and the outer surface of the core member, which are free of the above air gaps. Some examples of these are illustrated in FIGS. 2A to 2F, where for the sake of simplicity, hybrid structures are shown in cross-sections not passing through connector receiving elements. In other words, whilst the connector receiving elements of the hybrid structures illustrated in FIGS. 2A to 2F are not visible in these FIGURES, it is to be understood that each of these structures does include such elements as described above with respect to the hybrid structure 100, e.g. such elements as illustrated in FIGS. 1A to 1H.

FIGS. 2A and 2B illustrate a hybrid structure 200 having a core member 210 and a covering layer 220 corresponding to the core member and covering layer of the article 100 shown in FIGS. 1A to 1H, with the connector receiving elements not visible. The core member 210 has an outer surface 212 facing in the direction of the covering layer 220. The covering layer 220 has a plurality of bumps 225 protruding from an internal surface 222 in the direction of the core member 210 and spaced from each other by spacing regions 226 between any two adjacent bumps 225, so that when the covering layer 220 is connected to the core member 210 with the bumps 225 resting on an outer surface 212 of the core member 210, a reduceable-volume layer in the form of a plurality of air gaps G is formed between the spacing regions and the associated areas of the outer surface 212 underlying the spacing regions. The height of the bumps 225 define the height of the gaps and the covering layer 220 has a thickness at regions between the bumps 225, which is less than the height of the bumps 225. According to the illustrated embodiment, the bumps 225 are unitarily formed with the covering layer 220. However, in another embodiment (not shown), the bumps can be separately manufactured, and then assembled together with the covering layer.

The covering layer 220 and the air gaps G of the article/hybrid structure 200 are so configured, i.e. the covering layer 220 is made of such material and has such a thickness, and gaps G have such dimensions that, when a flexing force F is applied at an external surface 224 of the covering layer 220 at regions above the gaps G, the covering layer 220 slightly flexes inwardly into the gaps G, as best seen in FIG. 2B, and when the force F is removed, it flexes back to its normal shape.

In addition to the above described flexing, the core member 210 has compressibility higher than that of the covering layer 220, and areas of the outer surface 212 of the core member 210 underlying the bumps 225 are compressed when the flexing force F is applied on external surface 224 of the covering layer 220 at regions corresponding to the bumps 225, as shown in FIG. 2B and returns to the original shape when the force is removed.

The covering layer 220, while flexing, maintains its thickness at the regions where flexing force F is applied, and the internal and outer surfaces of the covering layer 220 flexes equally into the gaps G.

Thus, in the article/hybrid structure 200, suspension quality and a feeling of softness is achieved by the flexing of the covering layer as well as by compression of the core member at areas underlying the bumps. It is to be understood herein that the core member has a compressibility higher than that of the covering layer, but still lesser than that an elastic foam generally has. More particularly, the core member can be much lesser compressible if a force is applied over a large area thereof, and the compressibility of the core member is localized to the areas underlying the bumps. The dimensions of the bumps and the spacing regions, in a direction along the outer surface of the core member, effect the compressibility of the core member. For instance, the narrower the bumps are, higher is the compressibility of the core member at the areas underlying such bumps, as well as farther the bumps are from each other, higher is the compressibility of the core member at the areas underlying such bumps.

FIGS. 2C and 2D illustrate a sectional view of the hybrid structure 200, which in the illustrated embodiment additionally has snap-fitting connection arrangement.

More particularly, the hybrid structure 200 illustrated in FIGS. 2C and 2D has, in addition to the core member 210 and the covering layer 220 as illustrated in FIGS. 2A and 2B, snap-fitting connection arrangement comprising a plurality of female portions 218 extending inwardly into the core member 210 from the outer surface 212 thereof at areas of the core member 210 underlying some of the spacing regions 226, and a plurality of male portions 228 protruding from the internal surface 222 of the covering layer 220 at regions corresponding to the spacing regions and configured to be lockingly received in the respective female portions 218. In other words, each pair of male and female portions is associated with one of the gaps G.

The snap fitting connection arrangement of the hybrid structure 200 is suspension-allowing connection arrangement. For instance, the dimensions and configurations of the female portions 218 and male portions 228 are such that upon connection of the covering layer 220 with the core member 210, when the flexing force F is applied on the outer surface 224 of the covering layer 220 at regions corresponding to the male portions 228, the male portions 228 move within the female portions 218, thereby providing the suspension at the areas corresponding to the connection arrangement, in addition to the suspension provided by the flexing of the covering layer 220 at areas corresponding to the spacing regions 226 and by compression of the core member 210 at areas corresponding to the bumps 225 as described above. Thus, the covering layer 220, while being securely attached to the core member 210, is allowed to flex inwardly towards the core member 210 together with its male portions 228, at its regions associated with the male portions 218, and to be slightly moved relative to the core member in the tangential direction when the tangential force is at least indirectly applied to these regions.

FIG. 2E illustrate a sectional view of a hybrid structure 200′ having all the components and features of the article 200 described above with reference to FIGS. 2A and 2B, and additionally having a plurality of bumps protruding from the core member.

More particularly, the article 200′ has a core member 210′ and a covering layer 220′ both having the same basic configuration, made of the same materials (described at the end of the present description) and operating in the same manner as the respective covering layer and the core member of the article 200 shown in FIGS. 2A and 2B. The core member 210′ has an outer surface 212′ facing the covering layer 220′. The covering layer 220′ has an internal surface 222′ facing the core member 210′, and having a plurality of bumps 225′ protruding therefrom in the direction of the core member 210′ and spaced from each other by spacing regions 226′ between any two adjacent bumps 225′. The core member 210′ has a plurality of bumps 215′ protruding from the outer surface 212′ of the core member 210′ in the direction of the covering layer 220′ and spaced from each other by spacing regions 216′ between any two adjacent bumps 215′. In the illustrated example, the bumps 215′ and 225′ have dimensions in the direction extending from the core member to the covering layer such that when the covering layer 220′ is connected to the core member 210′, the internal surface 222′ of the covering layer 220′ rests on the bumps 215′ protruding from the core member 210′, and the bumps 225′ protruding from the covering layer 220′ rest on the outer surface 212′ of the core member 210′. A reduceable-volume layer in the form of a plurality of gaps G is formed between the spacing regions 226′ and the associated areas of the outer surface 212′ of the core member 210′ underlying the spacing regions 226′, and between the spacing regions 216′ the associated regions of the internal surface 222′ of the covering layer 220′ overlying the spacing regions 216′.

In some examples (not shown), the dimensions of the bumps 215′ and 225′ can be such that either the covering layer 220′ rests on the bumps 215′ and a space remains between the bumps 225′ and the core member 210′, or the bumps 225′ rest on the core member 210′ and a space remains between the covering layer 220′ and the bumps 215′.

The bumps 215′ and the bumps 225′ can be distributed along the corresponding surfaces of the core member 210′ and the covering layer 220′ in any pattern, uniform or non-uniform, and such that none of the bumps 215′ coincide with any of the bumps 225′. In other words, each of the bumps 215′ and 225′ are so arranged on the corresponding surfaces of the core member 210 and the covering layer 220 so as to align with spacing regions between the other of the bumps.

As also described above with respect to the covering layer 220 and gaps G of hybrid structure 200, the covering layer 220′ and the gaps G of the article/hybrid structure 200′ are so configured, i.e. the covering layer 220′ is made of such material and has such a thickness, and gaps G have such dimensions that, when a flexing force F is applied at an external surface 224′ of the covering layer 220′ at regions above the gaps G, the covering layer 220′ slightly flexes inwardly into the gaps G, and when the force F is removed, it flexes back to its normal shape.

In addition to the above described flexing, the core member 210′ has compressibility higher than that of the covering layer, and areas of the outer surface 212′ of the core member 210′ underlying the bumps 225′ are compressed when the flexing force F is applied on external surface 224′ of the covering layer 220′ at regions corresponding to the bumps 225′ and return to the original shape when the force is removed.

Further additionally, the bumps 215′ protruding from the core member 210′ are compressible in such a manner that when the flexing force F is applied on external surface 224′ of the covering layer 220′ at regions corresponding to the bumps 215′, the bumps 215′ are elastically compressed by that force.

Thus, in the article 200′, suspension quality and the feeling of softness is achieved by the flexing of the covering layer, by compression of the core member at areas underlying the bumps 225′, and by compression of the bumps 215.′ It is to be understood herein that the core member and/or bumps 215′ have a compressibility higher than that of the covering layer, but still lesser than that an elastic foam generally has.

FIG. 2F illustrates a sectional view of the hybrid structure 200′, which in the illustrated embodiment additionally has snap-fitting connection arrangement.

More particularly, the hybrid structure 200′ illustrated in FIG. 2F has, in addition to the core member 210′ and the covering layer 220′ as illustrated in FIG. 2E, snap-fitting connection arrangement, separate from the connector-connector receiving portion arrangement, comprising a plurality of female portions 218′ extending inwardly into the core member 210′ from the outer surface 212′ thereof at areas of the core member underlying some of the spacing regions 226′, and a plurality of male portions 228′ protruding from the internal surface 222′ of the covering layer 220′ at regions corresponding to the spacing regions and configured to be lockingly received in the respective female portions 218′. In other words, each pair of male and female portions is associated with one of the gaps G.

The snap fitting connection arrangement of the hybrid structure 200′ is suspension-allowing connection arrangement. For instance, the dimensions and configurations of the female portions 218′ and male portions 228′ are such that upon connection of the covering layer 220′ with the core member 210′, when the flexing force F is applied on the outer surface 224′ of the covering layer 220′ at regions corresponding to the male portions 228′, the male portions 228′ move within the female portions 218′, thereby providing the suspension at the areas corresponding to the connection arrangement, in addition to the suspension provided by the flexing of the covering layer 220′ at areas corresponding to the spacing regions and by compression of the core member 210′ at areas corresponding to the bumps 225′ as described above. Thus, the covering layer 220′, while being securely attached to the core member 210′, is allowed to flex inwardly towards the core member 210′ together with its male portions 228′, at its regions associated with the male portions 228′, and to be slightly moved relative to the core member 210′ in the tangential direction when the tangential force is at least indirectly applied to these regions.

Although the articles 200 and 200′ have been described with the air gaps and bumps constituting a reduceable volume layer which the covering layer can flex into, the reduceable layer volume layer can be constituted either by elastic layer disposed between the core member and the covering layer without the bumps, or by elastic layer portions disposed in the spacing regions between the above-described bumps.

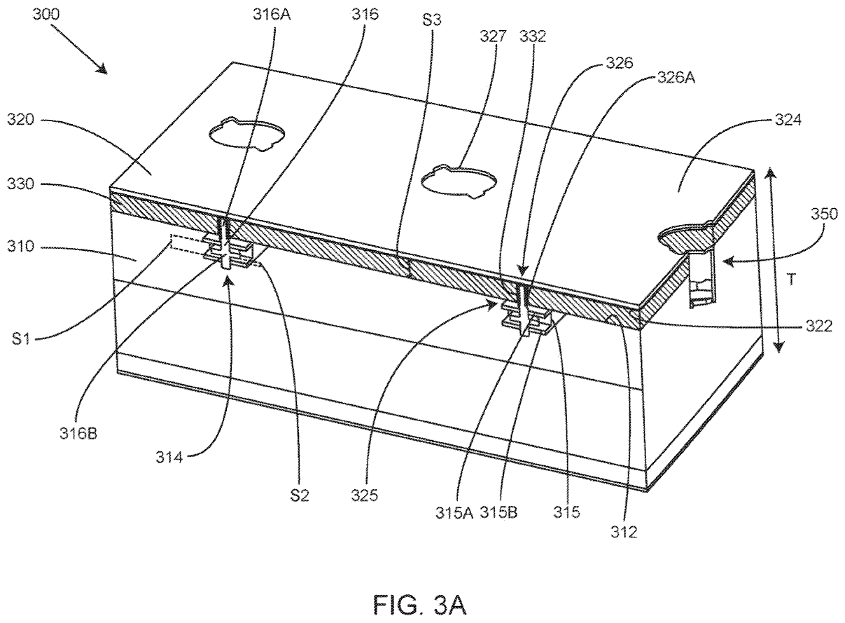

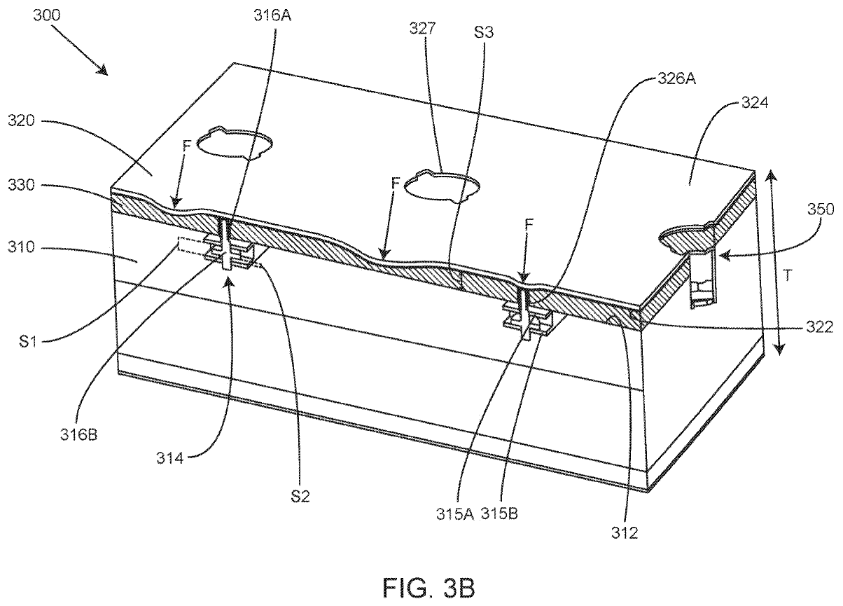

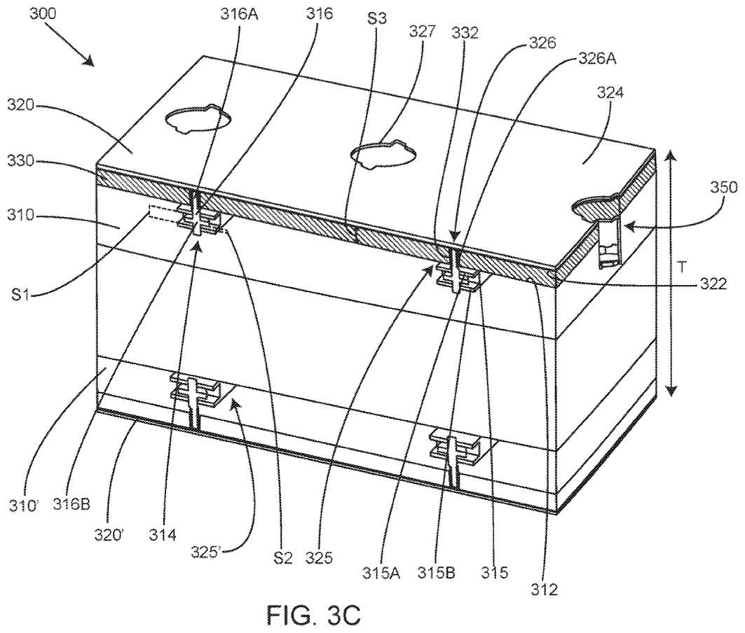

FIGS. 3A and 3B illustrate hybrid structures 300 having a suspension quality, in accordance with a further example of the subject matter of the present application, which comprises connector receiving elements as described above with respect to the hybrid structure illustrated in FIGS. 1A to 1H and connection arrangement according to an example different from those illustrated in FIGS. 2C, 2D, and 2F.

The hybrid structure/article 300 includes a core member 310, a covering layer 320, and a reduceable-volume layer 330, which in the illustrated embodiment is an elastic foam layer 330 sandwiched between the core member and the covering layer. The covering layer and the core member of the hybrid structure are configured to operate in the same manner as the core member and the covering layer of the hybrid structure 200 and 200′ described above thereby having the suspension qualities as described above. More particularly, the core member 310 has an outer surface 312 facing in the direction of the covering layer 320. The covering layer 320 has an internal surface 322 facing in the direction of the core member 310 and an external surface 324 facing towards the exterior of the article 300. The covering layer 320 is fixedly attached to the core member 310 via the elastic layer 330, by a suspension-allowing connection arrangement generally designated as 325. The core member and the covering layer are rigid, and the elastic layer is elastic enough to take the shape that of the outer surface 312 of the core member 310 and the internal surface of the covering layer upon assembly of the structure.

The covering layer 320 and the elastic layer 330 are made of such materials (described at the end of the present description) and have such thicknesses that, when a flexing force Fis applied at a region of the external surface 324 of the covering layer 320 along a thickness direction T of the structure, this region of the covering layer 320 flexes inwardly into the elastic layer 330. Thus, the suspension characteristics are achieved and the covering layer 320 provides a feeling of softness to the article like that of elastic foam. In other words, the covering layer 320 and the elastic layer 330 are configured so that each region of the covering layer 320 to which the force F is applied behaves like a membrane held in place by adjacent regions of the covering layer 320 where the force is not applied, with both the external surface 324 as well as the internal surface 322 of the covering layer 320 at these regions flexing inwardly into the elastic layer 330, as shown in FIG. 3B. Thus, when the force F is applied at a plurality of regions at the external surface 324 of the covering layer 320, and the covering layer 320 flexes into the elastic layer 330 at such regions, the volume of the elastic layer 330 under these regions is reduced. The covering layer 320 is capable of flexing upon application of force only when mounted so as to have reduceable volume underneath. In the absence of the reduceable volume, the covering layer 320 is not flexible, i.e., the volume of the covering layer 320 is not compressible itself upon the application of the flexing force, and when the covering layer 330 flexes, both the internal surface 322 and the outer surface 324 of the covering layer flex equally thereby maintaining the thickness of the covering layer 320 at the region of flexing.

In general, the connection arrangement by means of which the covering layer is fixedly connected to the core member, can include an array of lockable portions associated with the internal surface of the covering layer and an array of corresponding locking portions associated with the core member and at least indirectly lockingly engaging the lockable portions via the elastic layer. The locking portions can be reinforced relative to adjacent areas of the core member, i.e. the reinforced locking portions have a greater holding strength than that of areas of the core member adjacent thereto. The lockable portions can also be at least partially reinforced. The connection arrangement can be a quick fitting connection arrangement, in which a locking engagement can be provided, at least indirectly, between the lockable portions and the locking portions by a quick pushing action on the covering layer. The lockable portions can comprise lockable elements that can be formed as a unitary body with the covering layer and pairing members, which can also be reinforced, and the reinforced locking portions can be formed separately and positioned in the core member or can be integrally formed with the core member. The pairing members can each have an engaging portion, which can fixedly engage the lockable elements, optionally with a corresponding hole in the elastic layer, by the quick pushing action on the covering layer, thereby providing quick connection between the lockable portion and the locking portion.

In the illustrated embodiment, the lockable portions are designated as 326, their lockable elements are designated as 326A and their reinforced pairing members are designated as 316, the reinforced locking portions are designated as 314 and the elastic layer 330 includes holes 332 corresponding to the lockable portions 326 and the locking portions 314 allowing the lockable portions 326 and the locking portions 314 to lockingly engage each other therethrough.

Each of the locking portions 314 can include a support member and each of the pairing members can have, in addition to the engaging portion fixedly engaging the lockable element, optionally within the corresponding hole of the elastic layer, a restricted portion positioned within the support member so as to allow restricted displacement of the pairing member in the thickness direction T of the structure when the flexing force is applied to the corresponding region of the covering layer.

In the present example, each of the locking portions 314 includes a support member 315 having a first restricting surface 315A and a second restricting surface 315B spaced by a spacing S1 from the first restricting surface 315A. Each of the lockable portions 326 includes a lockable cup 326A and the corresponding elongated pairing member 316 having an engaging portion 316A tightly received in the lockable cup 326A within a corresponding hole in the elastic layer 330 and a restricted portion 316B positioned within the spacing S1 such that the restricted portion 316B is displaceable, upon the displacement of the pairing member 316, in the direction towards the covering layer 320 while remaining restricted within the spacing S1.

In order to connect the covering layer 320 to the core member 310, each lockable cup 326A is aligned with the corresponding pairing member 316, and when the lockable cup 326A engages with the engaging portion 316A of the pairing member 316 and the corresponding portion of the covering layer 320 is pushed further, the engaging portion 316A displaces in the direction of the pushing force until the restricted portion 316B abuts the second restricting surface 315B of the support member 315. A further push on the covering layer 320 causes the lockable cup 326A to tightly dress onto the engaging portion 316A thereby locking the lockable cup 326A to the pairing member 316. Upon removal of the pushing force, by virtue of the suspension quality of the covering layer 320, the pairing member 316 moves together with the corresponding lockable cup 326A away from the second restricting surface 315B, thereby leaving a spacing S2 between the restricted portion 316B of the pairing member 316 and the second restricting surface 315B. When the flexing force F is applied onto the covering layer 320 at a region corresponding to the locking portion 326, the spacing S2 allows the pairing member 316 to displace into the locking portion 314 thereby maintaining the suspension quality of the covering layer 320 at the regions corresponding to the connection between the covering layer 320 and the core member 310.

Further, as can be seen in FIG. 3A, the longitudinal dimensions of the lockable portions 326 including those of the engaging portions 316A of the pairing members 316 with the lockable cups 326A dressed thereon within the elastic layer 330, are such as to maintain a spacing S3 between the internal surface 322 of the covering layer 320 and the outer surface 312 of the core member 310 at portions of the elastic layer 330 adjacent to the lockable portions 326 when the flexing force is not applied. The spacing S3 allows the regions of the covering layer 320 corresponding to the lockable portions 326 to flex inwardly into the elastic layer 330 upon the application of the flexing force F.

In another embodiment (not shown), lockable portions of the covering layer can include lockable reinforced or non-reinforced protrusions protruding from the internal surface of the covering layer, and the locking portions can include reinforced locking recesses in the core member, each configured to irreversibly receive therein the corresponding lockable protrusion, while maintaining all other features of the connection arrangement as described above according to the illustrated embodiment.

In the illustrated example, the lockable cups 326A of the lockable portions 326 are formed integrally as a unitary body with the covering layer 320. In another embodiment (not shown), the entire lockable portions 326 can be separately formed and mounted to the covering layer 320.

In some examples, the locking portions and the lockable portions can have dimensions in a direction along the outer surface, so as to allow the covering layer to slightly move relative to the core member in the tangential direction, when respective flexing and tangential forces are at least indirectly applied to regions of the covering layer, resulting in an added dimension to the suspension characteristics of the covering layer, and thus, an improved feeling of softness to the article.

Although in the hybrid structure 300, the reduceable volume layer has been constituted by the elastic foam layer 330, it is to be understood herein the reduceable volume layer can be constituted by air gaps, in the same manner as in the hybrid structures 200 and 200′ or with additional elastic foam layer portions accommodated in such air gaps.

The hybrid structure/article 300 further includes connector receiving elements 350 (only one visible in FIGS. 3A and 3B) same in structure and operation as the connector receiving elements 150 described above with reference to FIG. 1D. As described above for the connector receiving elements 150, the connector receiving element 350 is also configured to allow axial displacement of a connector, when inserted and locked therewithin, thereby not interfering with the suspension quality of the structure at the areas corresponding to such connectors. As can be seen in FIGS. 3A and 3B, the covering layer 320 has holes 327 corresponding to and aligned with the connection receiving elements 350 and configured to allow insertion of the connector therethrough. In the illustrated examples, the connector passes through the elastic foam layer.

In any hybrid structure of the examples described above and any other hybrid structure according to the presently disclosed subject matter, the covering layer with its holes for connectors, the core member with its connector receiving portions, the reduceable volume therebetween if any, and their connection arrangement, can constitute a front part of a complex hybrid structure whose back and/or sides can include respective back/side portions of the core member, back/side portions of the covering layer and back/side elements of the connection arrangement.

One example of such complex hybrid structure is shown in FIG. 3C, in which the core member 310, the covering layer 320, and the connection arrangement 325 constitute a front part of the hybrid structure 300, and the core member 310′, the covering layer 320′ and the connection arrangement 325′ constitute the back part of the hybrid structure and are same in structure and operation as the core member 310, the covering layer 320, and the connection arrangement 325. The hybrid structure 300 further comprises a connection receiving element 350 forming a part of the front part of the hybrid structure and a similar connection receiving element can be positioned at the back part (not shown) allowing an add-on to be attached to the back part of the hybrid structure. Although in FIG. 3C, the elastic layer 330 is illustrated at the front part of the structure and not at the back part of the structure, it is to be understood herein that the front and the back parts can and cannot include the elastic layer, independently of each other, in different examples.

Any hybrid structure having a core member with locking portions of a connection arrangement of the hybrid structure and connector receiving elements within the core member configured to receive therein connectors by which an add-on can be connected to the hybrid structure, according to the presently disclosed subject matter, the locking portions and the connector receiving elements can have a common base portion, all together constituting a structure within the core member which can be reinforced and function as a skeleton of the core member of the hybrid structure thereby imparting strength to the structure. When the hybrid structure is complex and comprises back/side parts as described above, locking portions of their connection arrangement can constitute a part of the reinforced structure.

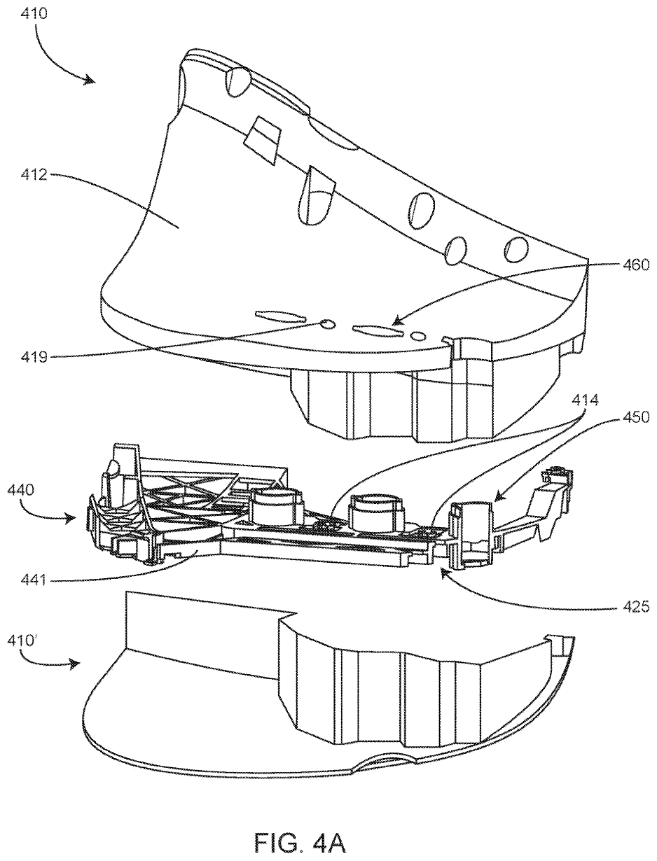

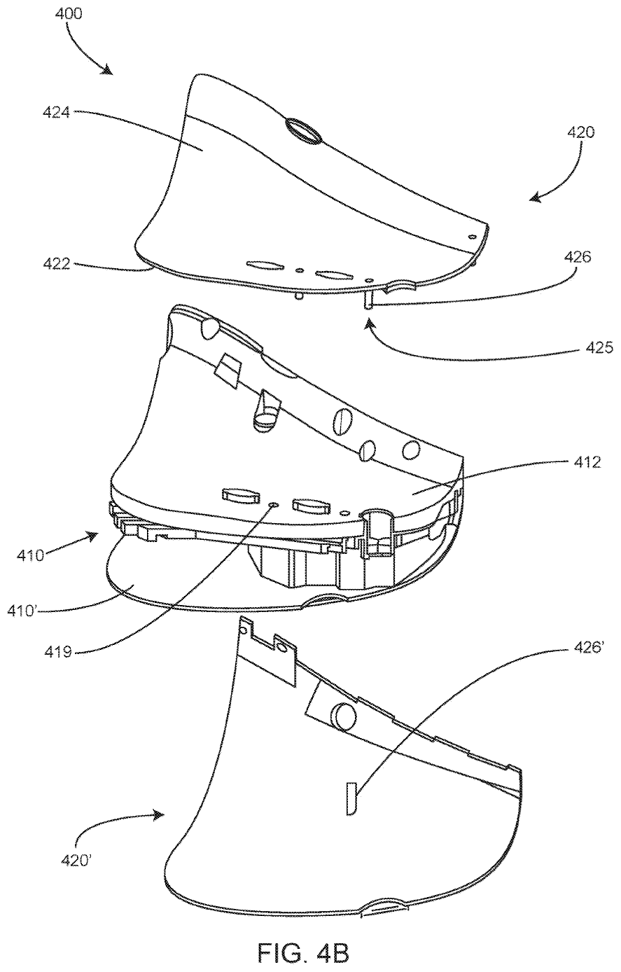

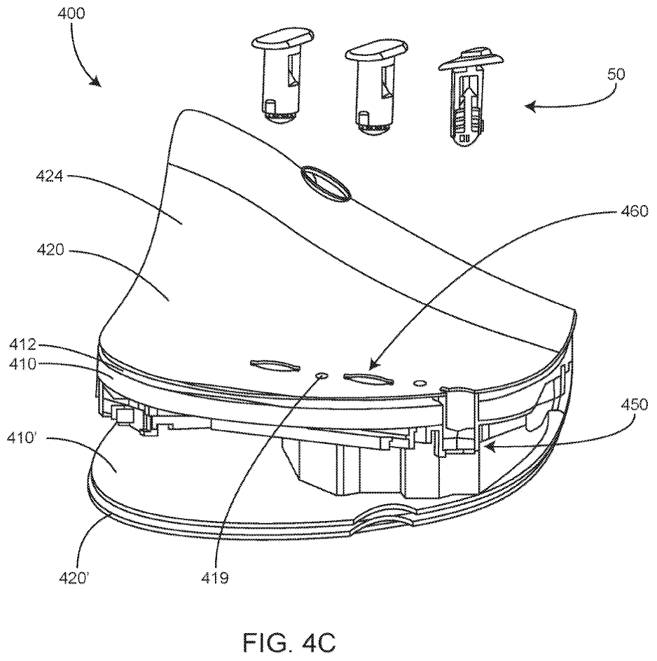

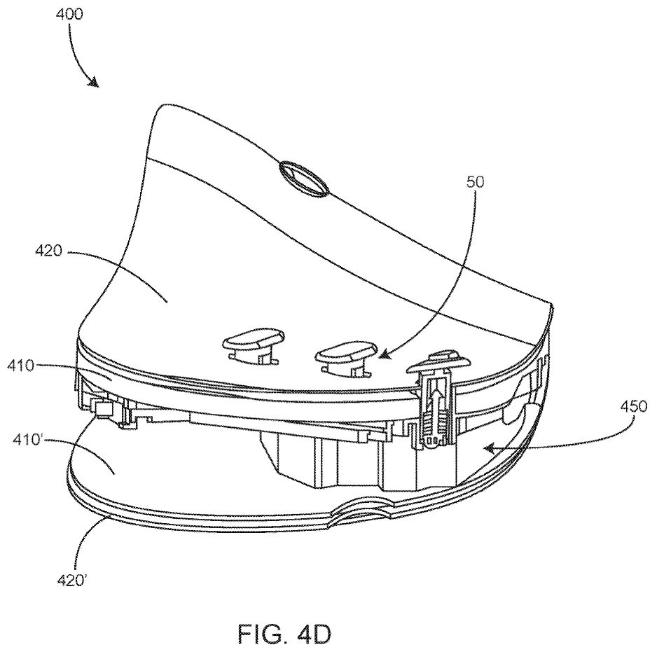

One example of a core member having such reinforced skeleton and front and back parts is shown in FIG. 4A. FIG. 4B illustrates an example of a complex hybrid structure comprising such core member, FIG. 4C the hybrid structure of FIG. 4B with an add-on connector not connected to it, and FIG. 4D the hybrid structure of FIG. 4B with an add-on connector connected to its front part.

With reference to FIGS. 4A and 4B, and similarly to the hybrid structures in the examples described above, a hybrid structure 400 includes a core member 410 having an outer surface 412, a covering layer 420 having an internal surface 422 and an external surface 424, and a connection arrangement 425 which includes lockable portions 426 associated with the covering layer 420 and locking portions 414 in the core member 410 accessible by the lockable portion via corresponding openings 419 similarly to the corresponding lockable and locking portions of the connection arrangement 325 of the hybrid structure 300. As can be seen in FIG. 4A, the core member 410 comprises a back portion 410′ constituting a back part of the core member 410, and can be seen in FIG. 4B, the covering layer 420 has a back portion 420′ constituting a back part of the hybrid structure 400 along with the back portion 410′ of the core member 410. The back portion 420′ of the covering layer is connected to the back portion 410′ of the core member a connection arrangement similar to the connection arrangement 425, of which the lockable portions 426′ can be seen in FIG. 4B.

The core member 410 comprises connector receiving elements 450 identical in structure and operation to the connector receiving elements 150 of the hybrid structure 100 described above with reference to FIGS. 1A-1E. The connector receiving elements 450 include all the features of the connector receiving elements 150 operative to lockingly receive therein connectors 50 for attaching thereto an add-on element. The connectors 50 can be locked within and unlocked from the connector receiving elements 450 in the same manner as described above with respect to connector receiving elements 150.

One difference between the connector receiving elements of the core member 410 and those of the hybrid structure 100 is that the connector receiving elements 450 are connected to each other by a common base portion 441 all forming a part of a continuous reinforced structure 440. The base portion 441 of the reinforced structure 440 constitutes a bridge between the connector receiving elements 450, connecting them together. The reinforced structure 440 can thus act as a skeleton for the core member 410 and of the entire hybrid structure 400 providing it with the ability to bear heavier loads thereupon.

In the illustrated example, the reinforced structure 440 is configured to be assembled with the core member 410 after both the reinforced structure 440 and the core member 410 have been (separately) fabricated. The reinforced structure 440 can be detachably assembled with the core member 410 via corresponding regions 460 formed in the core member 410. In other embodiments (not shown), the core member 410 can be over-molded over the reinforced structure 440.

As can be further seen in FIG. 4A, the locking portions 414 of the connection arrangement 425 constitute a part of the reinforced structure 440. Thus, the reinforced structure 440 can also facilitate a strong connection between the core member 410 and the covering layer 420.

As can be seen in FIGS. 4C and 4D the connector receiving elements 450 are configured to receive and lock therewithin the connector 50 in the same manner as described above with reference to connector receiving elements. In some examples (not shown), the reinforced structure can further include connector receiving elements and/or the locking portions on the other side of the reinforced structure being accessible from the back part of the hybrid structure via the back portion of the core member (in case of the locking portions) and the covering layer and the core member (in case of the connector receiving elements).

It is to be understood herein that the hybrid structures 100 and 400 can have the suspension qualities as described for the structures 200 and 200′ and the connection arrangement as described with respect to the structures 200, 200′, and 300, and can include a reduceable volume layer constituted in any manner as described above with respect to structures 200, 200′, and 300. Thus, a hybrid structure having the suspension qualities, the suspension allowing connection arrangements, and the connector receiving elements in any combination of the various examples of the presently disclosed subject matter, is to be understood as being within the scope of the presently disclosed subject matter.

In all of the above examples of the hybrid structure, almost all components thereof can be made of materials allowing their recycling including thermal processing thereof, without separation. For example, the materials of at least the core members, the covering layers, the connection arrangement including the lockable portions and locking portions, the connector receiving element/s and the reinforced structures, if any, with their reinforced base portions, can be meltable at the same recycling temperature. In particular, they can comprise the same basic substance or different basic substances that and said/each basic substance is the only substance within said materials that changes its form at said temperature. Since these materials can constitute more than 90%, optionally, more than 93%, e.g. at least 95%, of the weight of the entire hybrid structure, the structure can be recycled without separation even if the remaining materials in the structure are not meltable at the above temperature.

The basic substances can be recyclable thermoplastic polymers which differ in the material form between the core member, the covering layer, the connector receiving elements, and components of the connection arrangement.

One example of a hybrid structure and a core member of this kind can be such structure/core member where the basic substances in all the materials are of the same family of recyclable thermoplastic polymers, e.g. such as polypropylene, which in the core member can be in the form in an expanded particle foam and in the covering layer and the connector receiving element/s and the components of the connection arrangement can be in a compact form having a bulk density higher than that of the core member. In the latter example, the core member can be formed by particle-foam injection molding into a desired shape based on, and to dictate the shape of, the final product to be manufactured from the article; and the covering layer and the connection arrangement can be made by injection molding or compression molding, thermoforming, extrusion, vacuum forming, or other technologies, allowing the covering layer and the elements of the connection arrangement to maintain their shape as produced.

As mentioned above, the material/s of the covering layer and elements of the connection arrangement and connector receiving elements can have greater bulk density than the material of the core member. In some examples, the material of the reinforced components of the connection arrangement can have greater bulk density than that of the covering layer.

In one specific example where the thermoplastic polymer substance is polypropylene, when it is used to produce the expanded-particle-foam core member, such core member can have a bulk density of 25-250 gram/litre, more particularly, 30-120 gram/litre; when it used to produce the covering layer, such covering layer can have a density of 800-1000 gram/litre, more particularly, about 900 gram/litre; when it is used to produce the reinforced portions/structure of the core member, they can have a density of 900-1500 gram/litre. If the hybrid structure comprises an elastic foam layer whose basic substance is also polypropylene, such elastic layer can have a bulk density of 25-150 gram/litre, more particularly, 30-120 gram/litre.

The elastic layer, if any, can have weight, which can constitute a minor fraction of the weight of the entire hybrid structure, e.g. 5% or less, so even if it is made of a material not meltable at the above recycling temperature, it can be recycled together with the other components of the hybrid structure without separation therefrom.

The following are examples of the above materials all being polypropylene-based, which can be used in each of the hybrid structures described above:

| Name of | Material | Material | | |
|---|---|---|---|---|
| Component | Description | Grades | Supplier | Remarks |
| Injection Molded | Glass - fiber | TKG 2039N & | Lyondell Basell | The combination |
| Covering Layer | reinforced | TKS 209N | | of the two grades |
| | polypropylene | | | depends on the |
| | | | | softness to be |
| | | | | achieved. |
| Elastic Layer | Elastic | PP-25 (IXPP | Any supplier | |
| | Polypropylene | foam) | | |
| | Foam | | | |
| Core member | Expanded | EPERAN - | Kaneka Corp. | |
| formed by e | Polypropylene | PP MN20 | | |
| Reinforced | Glass - fiber | PPH3006 | Polyram Group | The combination |
| components of | reinforced | 7033 | ExxonMobil ™ | of the two grades |
| the connection | polypropylene | | | depends on the |
| arrangement | | | | softness to be |
| | | | | achieved. |

Examples described above allow a core member, a covering layer, and optionally, an elastic layer and/or a reinforced elements/portions/structure, all to be connected to each other by means which are free of any adhesives. Yet, if desired, an adhesive can be used between the covering layer and the core member or between one or both of these and the elastic layer, if any, or between the core member and the reinforced structure/reinforced elements/portions, for example if such adhesive is made of a material comprising the same basic substance as, but differing in its material form and physical characteristics from, those of the other components of the hybrid structure. One example of such basic material can be polypropylene.

1-43. (canceled)

44. A hybrid structure configured for detachably attaching thereto an add-on element by at least one connector, said hybrid structure comprising:
a core member having an outer surface and at least one connector receiving element positioned within the core member; and
a covering layer connected to the core member by a connection arrangement other than said connector, and having an internal surface configured to face the core member and an opposite external surface, said covering layer comprising at least one hole extending between its internal surface and external surface, said at least one hole being aligned with said at least one connector receiving element, for providing access thereto for said connector in a first orientation, and said connector receiving element being configured to allow displacement of said connector into a second orientation within the connector receiving element, thereby locking said connector therein.

45. The hybrid structure according to claim 44, wherein said connector receiving element is configured to allow displacement of said connector from the second orientation into the first orientation within the connector receiving element, thereby unlocking the connector.

46. The hybrid structure according to claim 44, wherein said hole is configured to allow removal of the connector from the connector receiving element in the first orientation.

47. The hybrid structure according to claim 44, wherein said connector receiving element is configured to allow rotation of the connector within the connector receiving element thereby allowing displacement of the connector between the first and the second orientation.

48. The hybrid structure according to claim 44, wherein said connector receiving element is configured to allow axial movement of the connector within the connector receiving element at least when the connector is in the second orientation.

49. The hybrid structure according to claim 44, wherein said core member comprises at least one opening in said outer surface, aligned with said hole in the covering layer, to provide access therethrough to the corresponding connector receiving element for said connector in the first orientation.

50. The hybrid structure according to claim 44, wherein the core member comprises a plurality of connector receiving elements including said at least one connector receiving element, said connector receiving elements constituting a part of a structure made of a material having at least one characteristic other than that of the material of the core member, the structure with the connector receiving elements being optionally formed as a unitary body.

51. The hybrid structure according to claim 44, wherein the connection arrangement comprises an array of lockable portions associated with the internal surface of the covering layer and an array of corresponding locking portions in the core member, said locking portions lockingly engaging at least partially the corresponding lockable portions.

52. The hybrid structure according to claim 44, further comprising a reduceable-volume layer disposed between the covering layer and at least a plurality of areas of the outer surface of the core member, and the covering layer is configured so that, upon application of a flexing force at any of a plurality of regions of the covering layer corresponding to said areas of the outer surface of the core member, each such region of the covering layer flexes inwardly into the reduceable-volume layer while maintaining the thickness of the covering layer at said region and flexes back when the force is removed, thereby providing the structure with a suspension quality.

53. The hybrid structure according to claim 52, wherein the reduceable-volume layer comprises a plurality of air gaps formed between the outer surface of the core member and the internal surface of the covering layer spaced from each other.

54. A kit, comprising:
the hybrid structure according to claim 44; and
at least one connector configured to be detachably attached at a first end thereof to the hybrid structure and at an opposite second end to an add-on to be attached to the hybrid structure.

55. A core member configured for connecting thereto a covering layer by a connection arrangement, and further configured for detachably attaching thereto an add-on element by at least one connector other than the connection arrangement, said core member comprising:
an array of locking portions constituting a part of the connection arrangement, said locking portions being configured to lockingly engage at least partially corresponding lockable portions associated with the covering layer; and
at least one connector receiving element other than the locking portions, said at least one connector receiving element being configured to be detachably connected to the add-on element by said connector.

56. The core member of claim 55, wherein the locking portions and said at least one connector receiving element being made of materials meltable at the same temperature.

57. The core member according to claim 55, wherein said connector receiving element is configured to receive therewithin said connector in a first orientation and to allow displacement of said connector into a second orientation within the connector receiving element, thereby locking said connector therein.

58. The core member according to claim 55, wherein said connector receiving element is configured to allow axial movement of the connector within the connector receiving element at least when the connector is in the second orientation.

59. The core member according to claim 55, wherein said core member comprises at least one opening in said outer surface, aligned with said connector receiving element, to provide access thereto for said connector.

60. The core member according to claim 55, wherein the core member comprises a plurality of connector receiving elements including said at least one connector receiving element, said connector receiving elements constituting a part of a structure made of a material having at least one characteristic other than that of the material of the core member, the structure with the connector receiving elements being optionally formed as a unitary body.

61. The core member according to claim 62, wherein said structure is reinforced relative to the core member.

62. The core member according to claim 62, wherein said structure is configured to be assembled with the core member after the core member and the structure have been fabricated.

63. The core member according to claim 62, wherein at least some of the locking portions constitute a part of said structure.
